(19) United States
(12) Patent Application Publication
(10) Pub. No.: US 2024/0320164 A1
(43) Pub. Date: Sep. 26, 2024

(54) METHODS AND APPARATUS TO AUTOMATICALLY PROVISION PERIPHERAL DATA

(71) Applicant: Intel Corporation, Santa Clara, CA (US)

(72) Inventors: Sean J. W. Lawrence, Bangalore (IN); Peter Mark Ewert, Hillsboro, OR (US); Sajal Kumar Das, Bangalore (IN); Sathyanarayana Nujella, Fremont, CA (US); Srikanth Potluri, Folsom, CA (US)

(21) Appl. No.: 18/737,654

(22) Filed: Jun. 7, 2024

(51) Int. Cl. G06F 13/10; G06F 9/455

(52) U.S. Cl. CPC G06F 13/102; G06F 9/45558; G06F 2009/45595

(57) ABSTRACT

Methods, apparatus, systems, and articles of manufacture to automatically provisional peripheral data are disclosed. An example apparatus includes at least one programmable circuit to use a machine learning model to select a first application or a second application based on context information associated with at least one of the first application, the second application, or an input signal from a peripheral device; and forward the input signal to the selected one of the first application or the second application.

### BACKGROUND

Computing devices include processing circuitry that perform various functions. Most computing devices include and/or are connected to peripheral devices that are connected (e.g., via a wired or wireless connection) to the processing circuitry of the computing device. Peripheral devices may include speakers, headphones, ear buds, microphones, keyboards, screens, user interfaces, mice, trackpads, touchscreens, etc. Peripherals obtain and/or output data to/from the processing circuitry to be output to a user and/or to be processed by the processing circuitry. A microphone may transmit sensed audio data to the processing circuitry, and an application implemented by the processing circuitry can output the obtained audio data to another device via a network communication. Audio generated by an application implemented by the processing device can be output to a speaker so that the speaker can output the audio to a user.

### BRIEF DESCRIPTION OF THE DRAWINGS

FIG. 1 is a block diagram of an example computing device to automatically provision peripheral data.

FIG. 2 is an example audio-based implementation of the computing device of FIG. 1.

FIG. 3 is a block diagram of an example implementation of the input redirector circuitry of FIG. 1.

FIG. 4 is a block diagram of an example implementation of the output redirector circuitry of FIG. 1.

FIG. 5 is a flowchart representative of example machine-readable instructions and/or operations that may be executed, instantiated, and/or performed by programmable circuitry to implement the input redirector circuitry of FIG. 3.

FIG. 6 is a flowchart representative of example machine-readable instructions and/or operations that may be executed, instantiated, and/or performed by programmable circuitry to implement the output redirector circuitry of FIG. 4.

FIG. 7 is a flowchart representative of example machine-readable instructions and/or operations that may be executed, instantiated, and/or performed by programmable circuitry to implement the input redirector circuitry and/or the output redirector circuitry of FIGS. 3 and/or 4.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine-readable instructions of FIG. 7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Computing devices can run one or more applications at the same time. For example, a computing device can run a gaming application at the same time as it runs a conference call application. However, cross pollination of data associated with the two or more applications can cause bugs, security issues, privacy issues, etc. For example, if a user is on a first conference call using a first application for work and a second call using a second application with their family, the audio of the user captured by the microphone that was intended for the family may not be appropriate to be output to the conference call and vice versa.

In the case of computing devices implementing one or more virtual execution environments (VEE), such as one or more containers and/or one of more virtual machines (VMs), the cross-pollination issue is more complicated. A virtual machine execution environment is a software-based environment that behaves like a physical computer in that it provides an environment in which software can be executed. A VEE is created using resources from a physical host computing device. A VM runs an operating system. A container does not have an operating system. Regardless, programs run within a VEE are isolated from the operating system and/or programs of the computing device on which the VEE runs. Similarly, programs within a VEE are isolated from programs in other VEEs operating on the computing device. Because VEEs are isolated from each other and/or the implementing computing device, a computing device may not know which VEE/program is to receive input data from peripherals. Accordingly, the computing device may forward input peripheral data to every application and/or VEE or the computing device may depend on the user to control which VEE is to receive the input peripheral data. Examples disclosed herein utilize techniques for automating provisioning peripheral data (e.g., input data or output data) to/from different applications and/or VEEs implemented in a computing device from/to peripheral devices in communication with the computing device.

Examples disclosed herein utilize context data corresponding to the applications and/or VEEs to determine how to automatically forward input data from peripheral devices. For example, examples disclosed herein may obtain audio data from a user and determine which application and/or VEE is to receive the audio data based on verbal context of the obtained input data or output data, usage context, application/VEE context, VEE system configuration (e.g., VM OS configuration) and/or events, etc. Verbal context may include one or more identified key word(s), subject(s) and/or object(s) related to an application/VEE, tone of input audio, loudness of input audio, pitch of input audio, etc. Usage context may include whether a meeting is occurring, whether a recorder is on or off, whether game play is occurring, etc. Application context may include application activity (e.g., what is happening in the application and/or what previously happened in the application, changes in activity, etc.), application usage patterns, etc.

For example, if a user is playing a game while wearing a headset and is concurrently on a call with a child, examples disclosed herein may forward input audio from the user to the call when the audio from the child corresponds to a question or silence, when the user uses a softer and/or quieter tone, when the user is not active in the game, when the game is in load screen or a low action portion, when the user uses words corresponding to a conversation with a child, etc. However, when the user voice is louder, when the user curses, when the user is discussing things related to the game, when the game is at a high action state, etc., examples disclosed herein forward the input audio of the user to the application running the game. Examples disclosed herein collect the information (e.g., metadata) from the applications and/or VEEs and make a decision for forwarding the input peripheral data automatically (e.g., without input from the user).

Additionally, examples disclosed herein can automatically output data from application(s) and/or VEE(s) to peripheral(s). For example, examples disclosed herein can obtain two or more audio data signals from application(s) and/or VEE(s). In such an example, examples disclosed herein can output the two or more audio data signals to the same peripheral device(s) (e.g., speakers, headphones, ear buds, etc.) or to different peripheral device(s). Examples disclosed herein can output a first audio signal to a first speaker or first earbud and output the second audio signal to a second speaker or a second earbud. In some examples disclosed herein, an audio signal is converted into text which is displayed on a user interface (instead of being audible) while an other audio signal is audible via the speaker, headset, etc. In some such examples disclosed herein, the audio signal is monitored based on verbal context, usage context, application context, and/or VEE system (e.g., OS) configurations and/or events to determine if the user needs to be alerted.

For example, because a user may be listening to audio from a first conference call while reading text from audio of a second conference call, the user may miss a queue that they should be responding to on one or both of the calls. Accordingly, examples disclosed herein can use the verbal context, usage context, application context, the VEE OS configuration and/or events to alert a user of a need to focus on a particular application.

Some examples disclosed herein utilize artificial intelligence to provisional peripheral data. Artificial intelligence (AI)-based models, such as machine learning models, deep learning models, neural networks, deep neural networks, etc. are used to perform a task (e.g., classify data). An AI-based model may be trained using data (e.g., unlabeled data or data correctly labelled with a particular classification). Training a traditional AI-model adjusts the weights of neurons of the neural network. After an AI-based model is trained, the AI-based model can be deployed for use. Data can be input into the deployed neural network and the weights of the neurons are applied (e.g., multiplied and accumulate) to input data to be able to process the input data to perform a function (e.g., classify data, generate text, etc.).

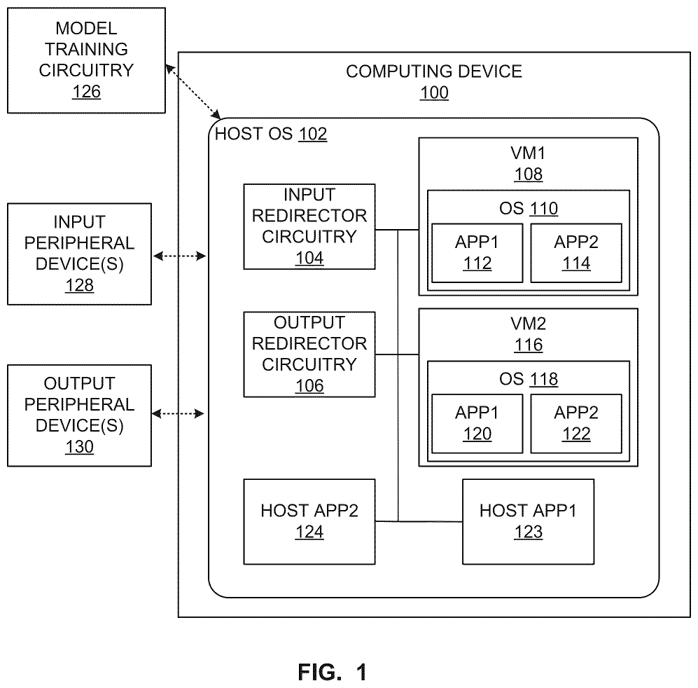

FIG. 1 illustrates an example computing device 100 to automatically provision (e.g., selects a recipient for) peripheral data. The computing device 100 includes an example host operating system (OS) 102, which includes example input redirector circuitry 104, example output redirector circuitry 106, example VEEs (in this example implemented as VMs) 108, 116, example VEE OSs 110, 118, example applications (apps) 112, 114, 120, 122, and example host apps 123, 124. FIG. 1 further includes example model training circuitry 126, example input peripheral device(s) 128, and example output peripheral device(s) 130. Although the example of FIG. 1 includes the model training circuitry 126, the input peripheral device(s) 128, and the output peripheral device(s) 130 implemented outside of the computing device 100, one or more of the model training circuitry 126, the input peripheral device(s) 128, and/or the output peripheral device(s) 130 may be implemented within the computing device 100.

The computing device 100 of FIG. 1 is a computing device that a user can use to implement the VEEs 108, 116 and/or host applications 123, 124. The computing device 100 may be a personal computer, a laptop, a tablet, a mobile device, a smart phone, a smart television, a video game system, an infotainment system, and/or any other device that can implement VEEs and/or applications. The computing device 100 includes the host OS 102 to manage the hardware and/or software resources of the computing device 100. The computing device of this example implements input redirector circuitry 104, output redirector circuitry 106, the VEEs 108, 116, and the host applications 123, 124. The OS 102 may include and/or be implemented by a basic input output system (BIOS) and/or a high-level OS, such as Microsoft Windows, Apple IOS, Android, LINUX, and/or any other operating system.

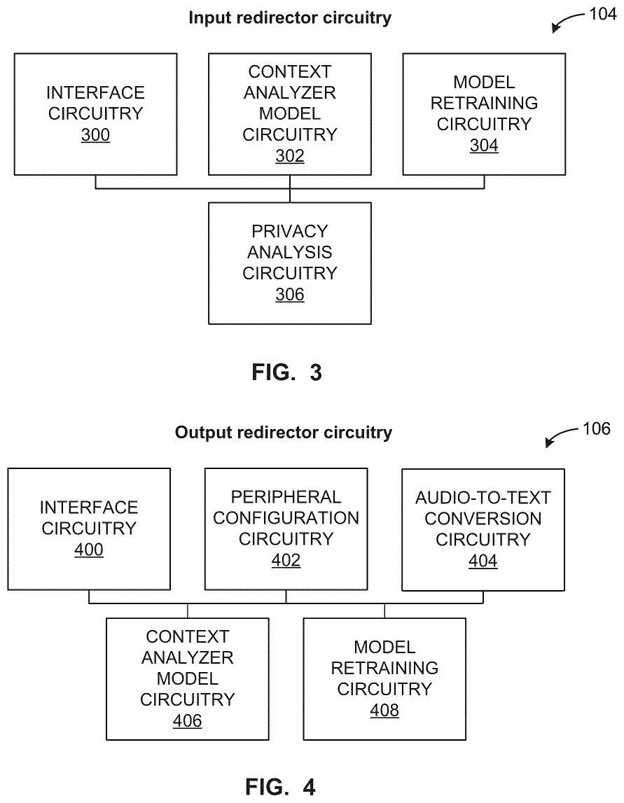

The example input redirector circuitry 104 of FIG. 1 redirects input data from the input peripheral device(s) 128 to one or more apps 112, 114, 120, 122 executing within a corresponding VEE 108, 116 and/or to one or more of the host apps 123, 124. For example, the input redirector circuitry 104 obtains audio data, video data, text data (e.g., from a touch screen, keyboard, etc.), control input data (e.g., from a touch screen, a mouse, a keyboard, a trackpad, etc.), etc. from one or more of the input peripheral device(s) 128. Additionally, the input redirector circuitry 104 may obtain context information (e.g., as metadata) from the applications 112, 114, 120, 122, 123, 124 and/or VEEs 108, 116. After the input redirector circuitry 104 obtains the input data, the input redirector circuitry 104 determines which application(s) 112, 114, 120, 122, 123, 124 and/or VEE (s) 108, 116 to send the input data to and which application(s) 112, 114, 120, 122, 123, 124 and/or VEE (s) 108, 116 to block the input data from reaching. For example, the input redirector circuitry 104 can utilize a trained artificial intelligence (AI)-based model to determine where to forward and where to block the input data. The AI-based model can utilize context information to determine where the input data should be forwarded or blocked. For example, the AI-based model may utilize verbal context of the input data or output data from one or more of the applications 112, 114, 120, 122, 123, 124, usage context of one or more of the applications 112, 114, 120, 122, 123, 124, application context of one or more of the applications 112, 114, 120, 122, 123, 124, and/or system configuration of the VEEs 108, 116. In some examples, the AI-based model may utilize other information in determining where to forward and where to block input data. For example, the AI-based model may utilize timing information (e.g., time of day, time of week, time of year, time of use within use of the application, etc.), use of other peripheral devices, etc. For example, the AI-based model may allow audio data from one of the input peripheral device(s) 128 (e.g., a microphone) to the application 112 when one of the output peripheral device(s) 130 is enabled (e.g., a camera) for the application 112 and block the audio data from the one of the input peripheral device 128 to the application 122 when the one of the output peripheral device 130 is disabled for the application 122. In some examples, the input redirector circuitry 104 provides the determination of which applications that input data have been forwarded to and which applications that have been blocked from the input data to the host OS 102 (e.g., using metadata). An example implementation of the input redirector circuitry 104 is further described below in conjunction with FIG. 3.

The example output redirector circuitry 106 of FIG. 1 determines where and/or how to output data from the applications 112, 114, 120, 122, 123, 124 to the output peripheral device(s) 130. For example, when the output redirector circuitry 106 obtains output audio data from two of the applications 112, 114, 120, 122, 123, 124, the output redirector circuitry 106 may output the first output data (e.g., audio) to a first portion (e.g., a first speaker, a first headphone, a first ear bud, etc.) of an output peripheral device 130 and the second output data (e.g., audio) to a second portion (e.g., a second speaker, a first headphone, a first ear bud, etc.) of the output peripheral device 130. In some examples, the output redirector circuitry 106 may output the first output data to a first one of the output peripheral devices 130 (e.g., headphones) and output the second output data to a second one of the output peripheral devices 130 (e.g., speakers). In some examples, the output redirector circuitry 106 may convert a first output signal to a different format. For example, if the first output signal and the second output signal are both audio signals, the output redirector circuitry 106 may convert the first output audio signal to a text output signal and display the text output signal on a first one of the output peripheral devices 130 (e.g., a user interface, a screen, a monitor, etc.) and output eh second audio output signal on a second one of the output peripheral devices 130 (e.g., a speaker, headphones, etc.). In this manner, a user can listen to the output audio from one application and read the output audio from another application at the same time.

In some examples, the output redirector circuitry 106 of FIG. 1 can utilize an AI-based model to analyze context data to determine whether to alert a user to pay attention to one or more of the applications 112, 114, 120, 122, 123, 124. For example, when two or more of the applications 112, 114, 120, 122, 123, 124 are outputting data to one or more of the output peripheral devices 130, the user may miss information from the two or more of the applications 112, 114, 120, 122, 123, 124. Accordingly, the AI-based model can track the context data related to the applications 112, 114, 120, 122, 123, 124, the VEEs 108, 116, and/or the peripheral devices 128, 130 to determine when to alert a user to one or more of the applications 112, 114, 120, 122, 123, 124. The context data may include the verbal context of the input data or output data from one or more of the applications 112, 114, 120, 122, 123, 124, the usage context of one or more of the applications 112, 114, 120, 122, 123, 124, the application context of one or more of the applications 112, 114, 120, 122, 123, 124, and/or the system configuration of the VEEs 108, 116. An example implementation of the output redirector circuitry 106 is further described below in conjunction with FIG. 4.

The VEEs 108, 116 of FIG. 1 are software-based environments that operate as physical computers using resources of the computing device 100. The VEEs 108, 116 operate independently and/or secluded from each other and the host operating system 102. If the VEEs 1098, 116 are VMs, the VEEs 108, 116 each include independent operating systems 110, 118. The operating systems 110, 118 each include two applications 112, 114, 120, 122. However, the computing device 100 may include any number of VEEs operating any number of applications. In some examples, one or more of the VEEs 108, 116 may implement one or more VEEs (e.g., nested VEE(s)). In such examples, one or more of the VEEs 108, 116, or nested VEEs may also include input redirector circuitry and output redirector circuitry 106 for control of input and output data with respect to the nested VEEs.

The applications 112, 114, 120, 122 of FIG. 1 are applications hosted by (e.g., that run on) one or more of the VEEs 108, 116 that obtain input data from the input peripheral device(s) 128 and/or transmit output data to the output peripheral device(s) 130. For example, the applications 112, 114, 120, 122 may be game application(s), conferencing application(s), phone application(s), chat application(s), communication application(s), social media application(s), and/or any other type of application that can obtain or output data to/from a peripheral device. Although the applications 112, 114, 120, 122 may utilize resources of the computing device 100, the host OS 102 does not control the apps 112, 114, 120, 122. Rather, the OS 110, 118 of the corresponding VEE 108, 116 controls the respective apps 112, 114, 120, 122 Additionally, the applications 112, 114, 120, 122 output context data (e.g., metadata) related to the use and/or context of the respective applications 112, 114, 120, 122. The VEE(s) 108, 116 output the context data to one or more of the input redirector circuitry 104 and/or the output redirector circuitry 106.

The host applications 123, 124 of FIG. 1 are applications that obtain input data from the input peripheral device(s) 128 and/or transmit output data to the output peripheral device(s) 130. For example, the Host applications 123, 124 may be game application(s), conferencing application(s), phone application(s), chat application(s), communication application(s), social media application(s), and/or any other type of application that can obtain or output data to/from a peripheral device. The host applications 123, 124 are controlled via the host OS 102.

When any one of the applications 112, 114, 120, 122, 123, 124 obtains input data from an input peripheral device, the applications 112, 114, 120, 122, 123, 124 can cause transmission of the data to an application running on an external computing device via a network communication. For example, when a user speaks into a microphone, the capture audio signal can be sent to the application 122, which uses interface circuitry of the computing device 100 to transmit the audio signal to another computing device so that the audio signal can be output via speakers, a headset, etc. of the other computing device.

The model training circuitry 126 of FIG. 1 is circuitry to train the AI-based model(s) implemented by the input redirector circuitry 104 and/or the output redirector circuitry 106. For example, the model training circuitry 126 trains an AI-based model to determine which applications to forward input data to and which applications to block the input data from reaching based on context data. Additionally, the model training circuitry 126 trains an AI-based model to determine whether to output an alert to a user based on the context data. The model training circuitry 126 can train one or more deep learning models, machine learning models, neural networks, and/or any other type(s) of AI-based models. After the model has been trained, the model training circuitry 126 deploys the trained model(s) to the host OS 102. In some examples, the model training circuitry 126 can store the trained model(s) in an external database and/or server, and the computing device 100 can obtain the trained model(s) from the external database and/or server.

The input peripheral device(s) 128 of FIG. 1 are devices that are not part of the host OS 102 but communicate with the host OS 102. For example, the input peripheral device(s) 128 may be microphone(s) to provide sensed audio data to the host OS 102, camera(s) or sensor(s) to provide sensed video data to the host OS 102, keyboard(s), touchscreen(s), mice, trackpad(s), controller(s), etc. to provide obtained control data to the host OS 102, and/or any other device that is capable of providing input data to the host OS 102. In some examples, one or more of the input peripheral device(s) 128 may operate as an input and output peripheral device. For example, an input and output peripheral device may include a headset may include a microphone and speakers to input sensed audio and output audio from the host OS 102 or a user interface (e.g., a touch screen display) that displays video and obtains input from a user.

The output peripheral device(s) 130 of FIG. 1 are devices that are not part of the host OS 102 but communicate with the host OS 102. For example, the output peripheral device(s) 130 may be speaker(s), headphone(s), ear bud(s), etc. to output audio data from the host OS 102, display(s), screen(s), monitor(s), etc. to output video data from the host OS 102, and/or any other device that is capable of outputting data from the host OS 102. In some examples, one or more of the output peripheral device(s) 130 may operate as an input and output peripheral device. For example, an input and output peripheral device may include a headset may include a microphone and speakers to input sensed audio and output audio from the host OS 102 or a user interface (e.g., a touch screen display) that displays video and obtains input from a user.

The model training circuitry 126, the input peripheral device(s) 128, and/or the output peripheral device(s) 120 of FIG. 1 can communicate (e.g., transmit or receive data) with the computing device 100 via a network communication (e.g., a wired and/or wireless connection).

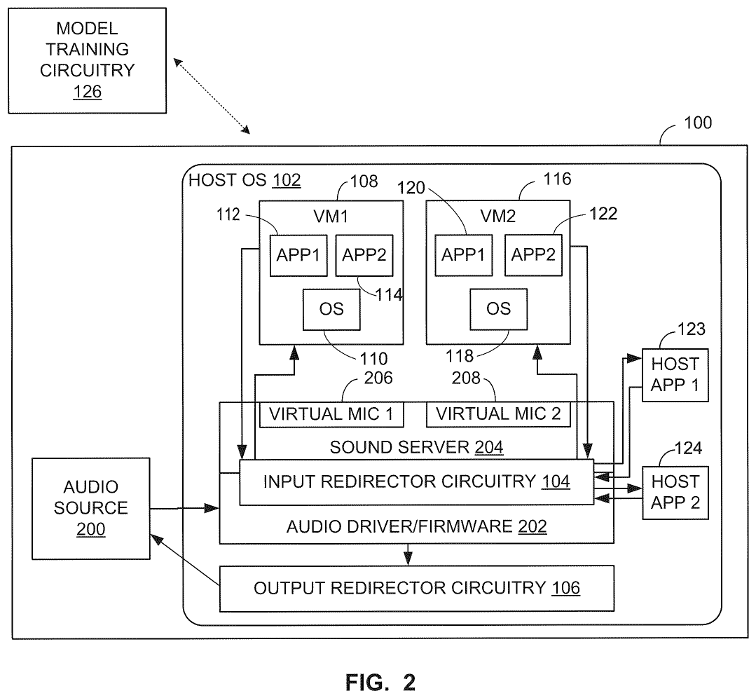

FIG. 2 illustrates an example implementation of the example computing device 100 to automatically provision peripheral data in the context of audio data. The computing device 100 includes the example host operating system (OS) 102, the example input redirector circuitry 104, the example output redirector circuitry 106, the example VEEs 108, 116, the example VEE OSs 110, 118, the example applications (apps) 112, 114, 120, 122, and the example host apps 123, 124 of FIG. 1. FIG. 2 further includes the example model training circuitry 126 of FIG. 1. The computing device 100 of FIG. 2 further includes an example audio source 200. The host OS 102 further includes an example audio driver/firmware 202, an example sound server 204, and example virtual microphones 206, 208.

The audio source 200 of FIG. 2 is an input and output peripheral device that is implemented in the computing device 100. However, as described above, the audio source 200 could be implemented outside of the computing device 100. The audio source 200 may be, for example, a headset that includes a microphone for obtaining input data and/or speakers for outputting output data. However, the audio source 200 could be implemented by a purely input peripheral device a purely output peripheral device, and/or any other type of peripheral device. The audio source 200 transmits input audio data (e.g., data sensed by the microphone of the audio source 200) to the input redirector circuitry 104. The audio source 200 also may obtain audio data from one or more of the applications 112, 114, 120, 122, 123, 124 via the output redirector circuitry 106.

The audio driver/firmware 202 of FIG. 2 allows the host OS 102 to communicate with the audio source 200 and/or other audio-based peripheral devices. The sound server 204 mixes different data streams and sends a single audio output to the audio source 200 via the audio driver/firmware 202. The sound server 204 includes the first virtual microphone 206 operating as an emulated microphone that can decode and play an audio stream for the VEE 108. The sound server 204 further includes the second virtual microphone 208 operating as an emulated microphone that can decode and play an audio stream for the VEE 116.

As shown in the example of FIG. 2, the input redirector circuitry 104 can be implemented by the audio driver/firmware 202 and/or the sound server 204. However, the input redirector circuitry 104 could be implemented outside of the audio driver/firmware 202 and/or sound server 204 using the host OS 102. Additionally, as shown in the example of FIG. 2, the output redirector circuitry 106 is implemented by the host OS 102. However, the output redirector circuitry 106 may be implemented by the audio driver/firmware 202 and/or the sound server 204.

In the example of FIG. 2, the audio source 200 obtains an audio signal from a microphone or other sensor. The audio source 200 transmits the audio signal to the input redirector circuitry 104. As described above, the input redirector circuitry 104 may, based on context data, determine that the audio signal should be forwarded to the app 112 and not to the applications 114, 120, 122, 123, 124. In such an example, the input redirector circuitry 104 passes the audio data to the app 122 and blocks, or otherwise prevents, the audio data signal from reaching the applications 114, 120, 122, 123, 124.

Additionally, if the application 112 and the host app 123 are outputting audio signals at the same time, the output redirector circuitry 106 can output both audio signals to the audio source 200 at the same time, output the first audio signal from the application 112 to a first speaker of the audio source 200 and output a second audio signal from the application 123 to a second speaker of the audio source 200, and/or may convert one of the first audio signal or the second audio signal to text and display the text on a screen, monitor, user interface while output the other one of the first audio signal or the second audio signal to the audio source 200.

FIG. 3 is a block diagram of an example implementation of the input redirector circuitry 104 of FIG. 1 to determine how to manage input data from the input peripheral(s) 128 of FIG. 1. The input redirector circuitry 104 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the input redirector circuitry 104 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers. The input redirector circuitry 104 of FIG. 3 includes example interface circuitry 300, example context analyzer model circuitry 302, example model retraining circuitry 304, and example privacy analysis circuitry 306.

The example interface circuitry 300 of FIG. 3 interfaces with the peripheral device(s) 128, 130, the VEEs 108, 116, and/or the host applications 123, 124. For example, the interface circuitry 300 can obtain input data from the input peripheral device 128 and context data via one or more of the applications 112, 114, 120, 122 (e.g., via the VEE 108, 116) and/or the applications 123, 124. Additionally, the interface circuitry 300 outputs an obtained input signal to one or more of the applications 112, 114, 120, 122, 123, 124 based on results of the context analyzer model circuitry 302. In some examples, the interface circuitry 300 can output a generated alert to a user via a user interface.

The context analyzer model circuitry 302 of FIG. 3 implements a model that has been trained to determine which applications 112, 114, 120, 122, 123, 124 to send input data to and which applications 112, 114, 120, 122, 123, 124 to prevent from obtaining the input data based on context data. In some examples, the context analyzer model circuitry can implement an AI-based model, such as a machine learning model, a deep learning model, a neural network, etc. As described above, the context data may include verbal context of the obtained input data from a peripheral device or output data from one or more applications, usage context, application/VEE context, VEE system configuration and/or events, timing information, etc. Verbal context may include identified key words, subject and objects related to an application/VEE that is to be output to a peripheral device, tone of input audio from a peripheral device, loudness of input audio from a peripheral device, pitch of input audio from a peripheral device, etc. Usage context may include whether a meeting is on or off, whether a recorder is on or off, whether game play is on or off, etc. Application context may include application activity (e.g., what is happening in the application and/or what previously happened in the application, changes in activity, etc.), application usage patterns, etc. Accordingly, the context analyzer model circuitry 302 uses context data to determine, in real time or substantially real time, which application a user intended audio data to go to without requiring the user to select the applications. Accordingly, the user can be using two applications that take in audio from a microphone at the same time, speak into the microphone, and have the audio data only go to the user-intended application(s). As described above, the model training circuitry 126 of FIG. 1 trains and deploys the model implemented by the context analyzer model circuitry 302.

The model retraining circuitry 304 of FIG. 3 processes actions of the user and/or actions taken by the context analyzer model circuitry 302 to tune and/or retrain the model implemented by the context analyzer model circuitry 302. In this manner, the model retraining circuitry 304 can further tune or customize the model to more accurately control input data based on previous actions by the user and/or context analyzer model circuitry 302. For example, a particular user can exhibit patterns that correspond to which app the user intends the input data to go to. For example, a particular user may take a shortened breath before speaking in a work conference call and not take the shortened breath before speaking in a personal call. The model retraining circuitry 304 can analyze and/or determine the patterns and adjust, tune, and/or retrain the model accordingly. In some examples, the user can provide feedback regarding the routing of audio data to the selected applications. In such examples, the model retraining circuitry 304 can use the user feedback to further adjust, tune, and/or retrain the model implemented by the context analyzer model circuitry 302.

The privacy analysis circuitry 306 of FIG. 3 analyzes and privacy concerns of a user to ensure that any user-selected privacy settings are satisfied. The privacy settings may include particular situations where the user and/or another device has defined where input data should and should not be forwarded to. For example, a user can mute themselves for one application and not the other. In such an example, even if the context analyzer model circuitry 302 determines that the input data be output to an application, the privacy analysis circuitry 306 will prevent the input data from going to the selected application. In some examples, the privacy analysis circuitry 306 can output an alert and/or indication (e.g., via the interface circuitry 300) to a user interface to warn the user that the input data has been blocked to the application that the context analyzer model circuitry 302 selected. In this manner, if the user accidentally muted an application, the user can be warned of the potential accidental mute and take corrective actions.

FIG. 4 is a block diagram of an example implementation of the output redirector circuitry 106 of FIG. 1 to determine how to manage output data to the output peripheral(s) 130 of FIG. 1. The output redirector circuitry 106 of FIG. 4 may be instantiated (e.g., creating an instance of, bring into being for any length of time, materialize, implement, etc.) by programmable circuitry such as a Central Processor Unit (CPU) executing first instructions. Additionally or alternatively, the output redirector circuitry 106 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers. The input redirector circuitry 104 of FIG. 4 includes example interface circuitry 400, example peripheral configuration circuitry 402, example audio-to-text conversion circuitry 404, example context analyzer model circuitry 406, and example model retraining circuitry 408.

The example interface circuitry 400 of FIG. 4 interfaces with the peripheral device(s) 128, 130, the VEEs 108, 116, and/or the host applications 123, 124. For example, the interface circuitry 400 can obtain input data from input peripheral device 128 and context data via one or more of the applications 112, 114, 120, 122 (e.g., via the VEE 108, 116) and/or the applications 123, 124. Additionally, the interface circuitry 400 outputs obtained output signals from one or more of the applications 112, 114, 120, 122, 123, 124 to the output peripheral device(s) 130. In some examples, the interface circuitry 400 can output a generated alert to a user via a user interface.

The peripheral configuration circuitry 402 of FIG. 4 determines how to output data from one or more of the applications 112, 114, 120, 122, 123, 124 to the output peripheral device(s) 130 of FIG. 1. For example, if only one of the applications 112, 114, 120, 122, 123, 124 is outputting audio data, the peripheral configuration circuitry 402 outputs the audio data via the output peripheral device(s) 130 that are capable of outputting audio data (e.g., speakers, headsets, headphones, ear buds, etc.). If two or more of the applications 112, 114, 120, 122, 123, 124 are outputting audio signals, the peripheral configuration circuitry 402 may (i) output the multiple audio signal on one or more of the output peripheral device(s) 130 that are capable of outputting audio, (ii) output different audio signals to different ones of the output peripheral device(s) 130 that are capable of outputting audio (e.g., output first audio output data to speakers and second audio output data to headphones), (iii) output different audio signals to different portions of the same output peripheral device capable of outputting audio (e.g., output first audio output data to a first ear bud and second audio output data to a second ear bud), or (iv) output first audio output data via one or more of the output peripheral device(s) 130 capable of outputting audio and output text corresponding to the second audio output data via a user interface. The peripheral configuration circuitry 402 can determine how to control the output data based on user and/or manufacturer preferences.

The audio-to-text conversion circuitry 404 of FIG. 4 converts an output audio signal into text. As described above, the peripheral configuration circuitry 402 may output first output audio data to a speaker and output text corresponding to second audio output data to a user interface. Accordingly, the audio-to-text conversion circuitry 404 converts one or more output audio streams to text to be displayed on the user interface.

The context analyzer model circuitry 406 of FIG. 4 implements a model that has been trained to determine whether to alert a user to a particular application based on context data. The model may be an AI-based model, such as a deep learning model, a machine learning model, a neural network, etc. As described above, the context data may include verbal context of the obtained input data from a peripheral device or output data from one or more applications, usage context, application/VEE context, VEE system configuration and/or events, timing information, etc. Accordingly, the context analyzer model circuitry 406 uses context data to determine, in real time or substantially real time, where to alert the user to pay attention to a particular application. For example, if a user is listening to two audio streams at the same time or reading one or more streams while listening to an audio stream, the user can easily miss information and/or a question posed to the user from one of the applications. Thus, the context analyzer model circuitry 406 can monitor the output streams and generate an alert to the user in real-time and/or near real-time when the user attention may be needed for a particular application. As described above, the model training circuitry 126 of FIG. 1 trains and deploys the model implemented by the context analyzer model circuitry 406.

The model retraining circuitry 408 of FIG. 3 processes actions of the user and/or actions taken by the context analyzer model circuitry 406 to tune and/or retrain the model implemented by the context analyzer model circuitry 302. In this manner, the model retraining circuitry 408 can further tune or customize the model to more accurately determine when to alert a user based on previous actions by the user and/or context analyzer model circuitry 302. For example, the user can provide feedback regarding a generated alert being useful or not useful or a lack of an alert. In such examples, the model retraining circuitry 408 can use the user feedback to further adjust, tune, and/or retrain the model implemented by the context analyzer model circuitry 406.

While an example manner of implementing the input redirector circuitry 104 and the output redirector circuitry 106 of FIG. 1 is illustrated in FIGS. 3-4, one or more of the elements, processes, and/or devices illustrated in FIGS. 3-4 may be combined, divided, re-arranged, omitted, eliminated, and/or implemented in any other way. Further, the interface circuitry 300, the context analyzer model circuitry 302, the model retraining circuitry 304, the privacy analysis circuitry 306, the interface circuitry 400, the peripheral configuration circuitry 402, the audio-to-text conversion circuitry 404, the context analyzer model circuitry 406, the model retraining circuitry 408, and/or, more generally, the input redirector circuitry 104 and the output redirector circuitry 106 of FIGS. 3-4, may be implemented by hardware alone or by hardware in combination with software and/or firmware. Thus, for example, any of the interface circuitry 300, the context analyzer model circuitry 302, the model retraining circuitry 304, the privacy analysis circuitry 306, the interface circuitry 400, the peripheral configuration circuitry 402, the audio-to-text conversion circuitry 404, the context analyzer model circuitry 406, the model retraining circuitry 408, and/or, more generally, the input redirector circuitry 104 and the output redirector circuitry 106 of FIGS. 3-4, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the input redirector circuitry 104 and the output redirector circuitry 106 of FIGS. 3-4 may include one or more elements, processes, and/or devices in addition to, or instead of, those illustrated in FIGS. 1-4, and/or may include more than one of any or all of the illustrated elements, processes, and devices.

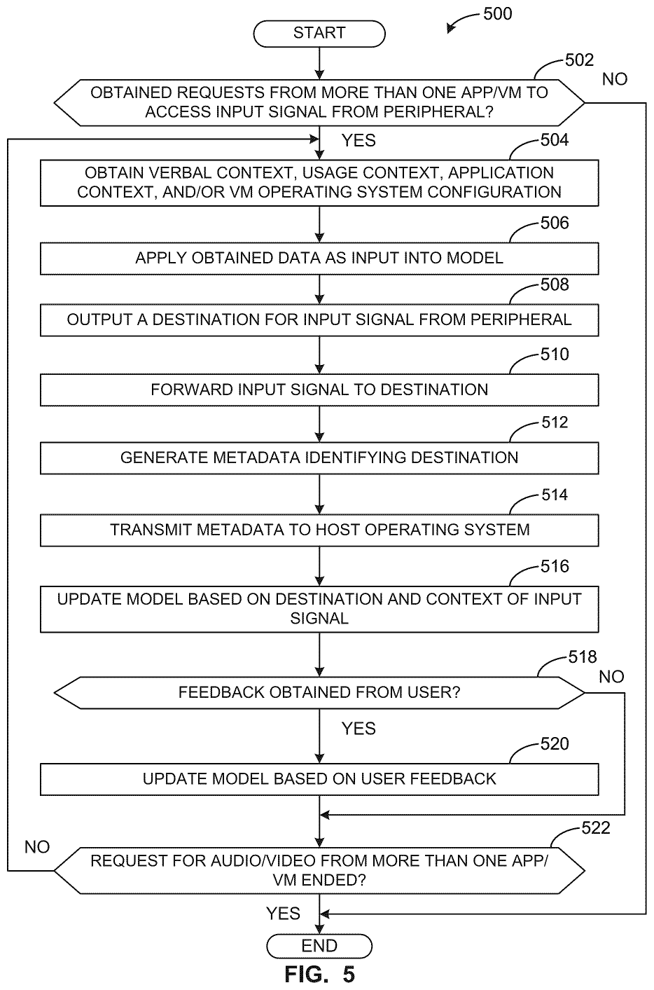

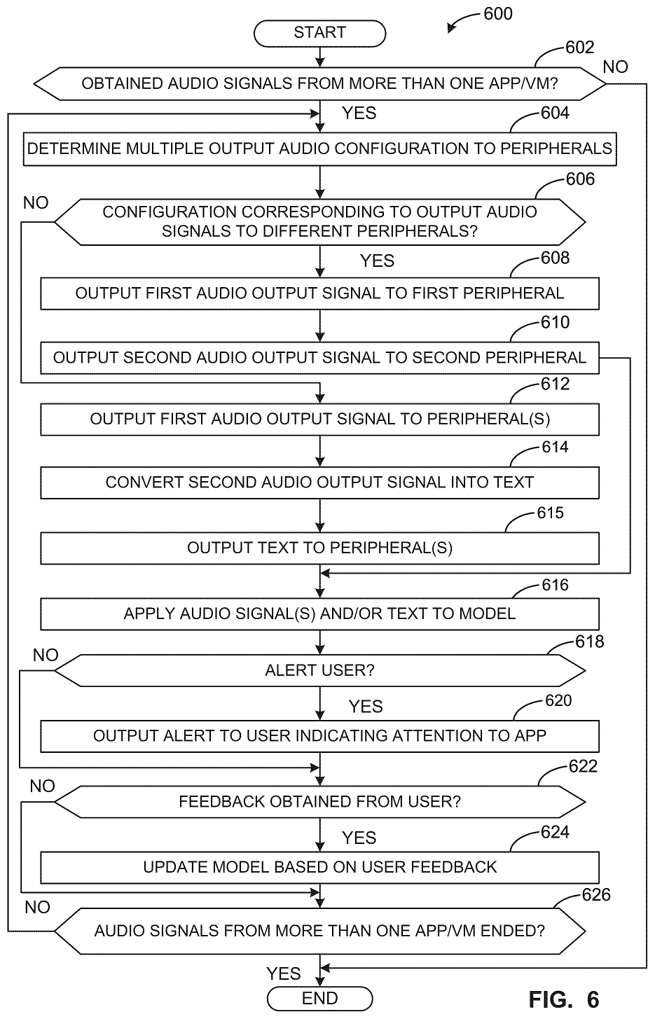

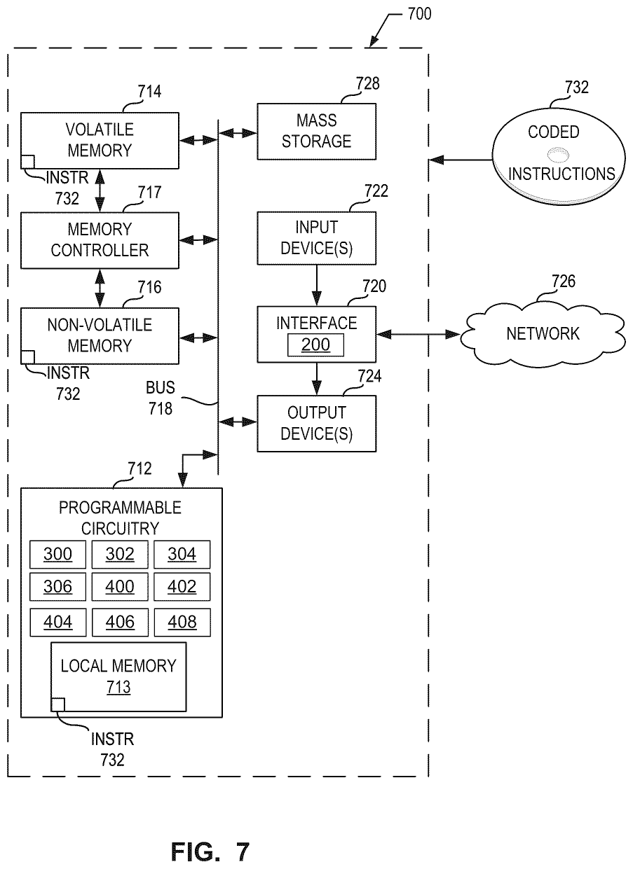

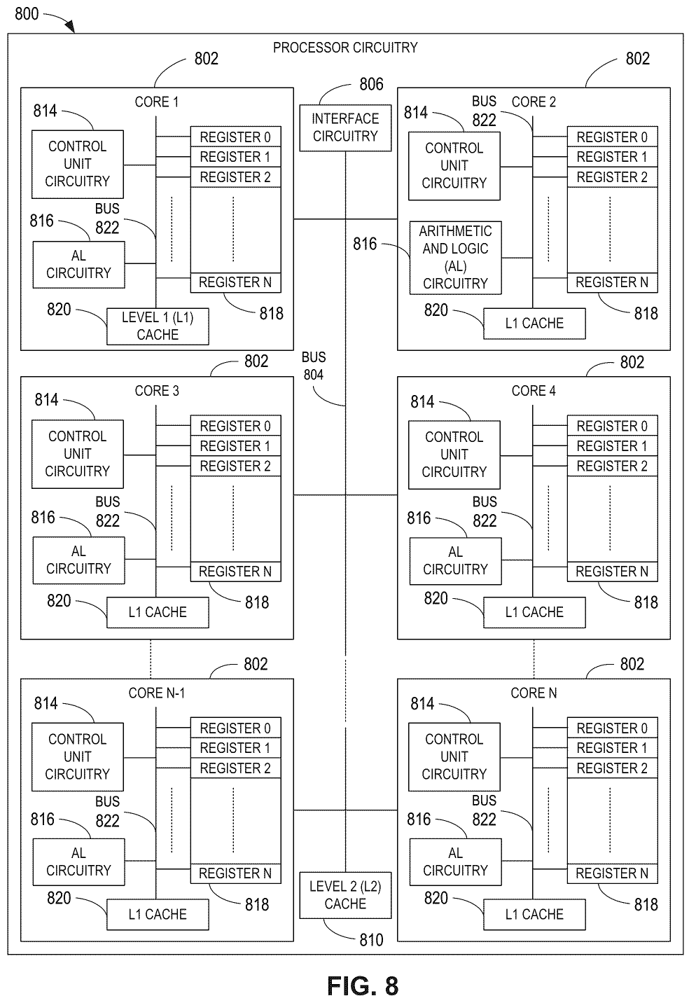

Flowchart(s) representative of example machine-readable instructions, which may be executed by programmable circuitry to implement and/or instantiate the input redirector circuitry 104 and the output redirector circuitry 106 of FIGS. 3-4 and/or representative of example operations which may be performed by programmable circuitry to implement and/or instantiate the input redirector circuitry 104 and the output redirector circuitry 106 of FIGS. 3-4, is shown in FIGS. 5-6. The machine-readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 7. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 5-6, many other methods of implementing the input redirector circuitry 104 and the output redirector circuitry 106 of FIGS. 3-4 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable, and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, Go Lang, etc.

As mentioned above, the example operations of FIG. 3 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or operations, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or operations, the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Descriptors “first,” “second,” “third,” etc. are used herein when identifying multiple elements or components which may be referred to separately. Unless otherwise specified or understood based on their context of use, such descriptors are not intended to impute any meaning of priority or ordering in time but merely as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

FIG. 5 is a flowchart representative of example machine-readable instructions and/or example operations 500 that may be executed, instantiated, and/or performed by programmable circuitry(ies) to control input data from the input peripheral device(s) 128 of FIG. 1. For example, the example operations 500 may be executed, instantiated, and/or performed by the input redirector circuitry 104 of FIG. 3. The example machine-readable instructions and/or the example operations 500 of FIG. 5 begin at block 502, at which the context analyzer model circuitry 302 determines if the interface circuitry 300 has obtained requests from more than one of the applications 112, 114, 120, 122, 123, 124 and/or VEEs 108, 116 to access an input signal from one or more of the input peripheral devices 128. For example, two video conference applications, phone applications, game applications, social media applications, etc. may request access to input data obtained from an input peripheral device.

If the context analyzer model circuitry 302 determines that requests from more than one of the applications 112, 114, 120, 122, 123, 124 and/or VEEs 108, 116 have not been obtained (block 502: NO), the instructions end. If the context analyzer model circuitry 302 determines that requests from more than one of the applications 112, 114, 120, 122, 123, 124 and/or VEEs 108, 116 have been obtained (block 502: YES), the context analyzer model circuitry 302 obtains verbal context, usage context, application context, and/or VEE system configuration information from one or more of the applications 112, 114, 120, 122, 123, 124, the VEEs 108, 116, the input peripheral device(s) 128, and/or the output peripheral device(s) 130 (block 504).

At block 506, the context analyzer model circuitry 302 applies the obtained data as input into a trained model. As described above, the trained model is trained by the model training circuitry 126 to determine which applications to send input audio data based on context data. At block 508, the example context analyzer model circuitry 302 outputs a destination (e.g., a selection of one or more of the applications 112, 114, 120, 122, 123, 124) for the input signal from the peripheral device based on the context data. At block 510, the interface circuitry 300 forwards the input signal to the destination (e.g., the selected one or more of the applications 112, 114, 120, 122, 123, 124) and blocks the input signal from reaching the one or more applications 112, 114, 120, 122, 123, 124 that were not selected as being part of the destination.

At block 512, the context analyzer model circuitry 302 generates metadata identifying the selected destination. At block 514, the interface circuitry 300 outputs the metadata to the host OS 102 of FIG. 1. At block 516, the model retraining circuitry 304 updates (e.g., tunes, retrains, etc.) the model used by the context analyzer model circuitry 302 based on the destination and/or the context of the input signal. For example, the model retraining circuitry 304 can identify patterns of the user and update the model accordingly, as described above in conjunction with FIG. 3.

At block 518, the model retraining circuitry 304 determines if feedback has been obtained from a user via the interface circuitry 300. For example, the user may indicate that the selected destination was accurate or inaccurate and/or otherwise provide details related to the control of the input data. If the model retraining circuitry 304 determines that the feedback has not been obtained (block 518: NO), control continues to block 522. If the model retraining circuitry 304 determines that the feedback has been obtained (block 518: YES), the model retraining circuitry 304 updates (e.g., tunes, retrains, etc.) the model implemented by the context analyzer model circuitry 302 based on the user feedback (block 520).

At block 522, the context analyzer model circuitry 302 determines if the requests from more than one of the applications 112, 114, 120, 122, 123, 124 and/or VEEs 108, 116 to access an input signal from one or more of the input peripheral devices 128 has ended. If the context analyzer model circuitry 302 determines that the requests have not ended (block 522: NO), control returns to block 504. If the context analyzer model circuitry 302 determines that the requests have ended (block 522: YES), the instructions end.

FIG. 6 is a flowchart representative of example machine-readable instructions and/or example operations 600 that may be executed, instantiated, and/or performed by programmable circuitry(ies) to control output data to the output peripheral device(s) 130 of FIG. 1. For example, the example operations 600 may be executed, instantiated, and/or performed by the output redirector circuitry 106 of FIG. 4. The example machine-readable instructions and/or the example operations 600 of FIG. 6 begin at block 602, at which the peripheral configuration circuitry 402 determines if the interface circuitry 400 has obtained two or more audio signal from two or more of the applications 112, 114, 120, 122, 123, 124 and/or VEEs 108, 116.

If the peripheral configuration circuitry 402 determines that the two or more audio signals have not been obtained (block 602: NO), the instructions end. If the peripheral configuration circuitry 402 determines that the two or more audio signals have been obtained (block 602: YES), the peripheral configuration circuitry 402 determines the multiple output audio configuration to the output peripheral(s) 130 (block 604). The multiple output audio configuration corresponds to how to output the multiple audio signals to the one or more output peripheral(s) 130. The multiple output audio configuration may be based on user and/or manufacturer preferences.

At block 606, the peripheral configuration circuitry 402 determines if the multiple output audio configuration corresponds to outputting the audio signal to different peripherals and/or different portions of the same peripheral. If the peripheral configuration circuitry 402 determines that the multiple output audio configuration does not correspond to outputting the audio signals to different peripheral devices (block 606: NO), control continues to block 612. If the peripheral configuration circuitry 402 determines that the multiple output audio configuration corresponds to outputting the audio signals to different peripheral devices and/or different portions of the same peripheral device (block 606: YES), the peripheral configuration circuitry 402 outputs the first audio output signal to the first output peripheral device or the first portion of the first peripheral device (block 608). At block 610, the peripheral configuration circuitry 402 outputs the second audio output signal to the second output peripheral device or the second portion of the first peripheral device. In some examples, the multiple output audio configuration may correspond to outputting all output audio signals to all audio-based output peripherals, as further described above in conjunction with FIG. 4. After block 610, control continues to block 618.

If the peripheral configuration circuitry 402 determines that the multiple output audio configuration does not correspond to outputting the audio signals to different peripheral devices (block 606: NO), the peripheral configuration circuitry outputs the first audio output signal to a first one or more of the output peripherals 130 (block 612). At block 614, the audio-to-text conversion circuitry 404 converts the second audio output signal into text. At block 615, the audio-to-text conversion circuitry 404 outputs the text to a visual based output peripheral (e.g., a screen, a monitor, a user interface, etc.). At block 616, the context analyzer model circuitry 406 applies (e.g., inputs) the audio signal(s) and/or the text to a trained model. As described above, the model training circuitry 126 of FIG. 1 trains the model to, based on context data, determine whether to output an alert to a user.

At block 618, the context analyzer model circuitry 406 determines whether to alert a user to one or more applications based on the input context data. If the context analyzer model circuitry 406 determines that the user should not be alerted to one or more applications (block 618: NO), control continues to block 622. If the context analyzer model circuitry 406 determines that the user should be alerted to one or more applications (block 618: YES), the context analyzer model circuitry 406 outputs an alert to a user interface (e.g., one of the output peripherals 130 of FIG. 1) via the interface circuitry 400 (block 620).

At block 622, the model retraining circuitry 408 determines if feedback has been obtained from a user via the interface circuitry 400. For example, the user may indicate that the alert was accurate or inaccurate and/or otherwise provide details related to the alert. If the model retraining circuitry 408 determines that the feedback has not been obtained (block 622: NO), control continues to block 626. If the model retraining circuitry 408 determines that the feedback has been obtained (block 622: YES), the model retraining circuitry 408 updates (e.g., tunes, retrains, etc.) the model implemented by the context analyzer model circuitry 406 based on the user feedback (block 624).

At block 626, the peripheral configuration circuitry 402 determines if the audio signals from the more than one application/VEE have ended. If the peripheral configuration circuitry 402 determines that the audio signals have not ended (block 626: NO), control returns to block 604. If the peripheral configuration circuitry 402 determines that the audio signals have ended (block 626: YES), the instructions end.

FIG. 7 is a block diagram of an example programmable circuitry platform 700 structured to execute and/or instantiate the example machine-readable instructions and/or the example operations of FIGS. 5-6 to implement the input redirector circuitry 104 and/or the output redirector circuitry 106 of FIGS. 3-4. The programmable circuitry platform 700 can be, for example, a server, a personal computer, a workstation, a self-learning machine (e.g., a neural network), or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. In this example, the interface circuitry 300, the context analyzer model circuitry 302, the model retraining circuitry 304, the privacy analysis circuitry 306, the interface circuitry 400, the peripheral configuration circuitry 402, the audio-to-text conversion circuitry 404, the context analyzer model circuitry 406, and/or the model retraining circuitry 408 of FIGS. 3-4.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, a keyboard, a button, a mouse, and/or a touchscreen.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, an optical fiber connection, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 732, which may be implemented by the machine-readable instructions of FIGS. 5-6, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIG. 3 to effectively instantiate the circuitry of FIGS. 1 and/or 2 as logic circuits to perform operations corresponding to those machine-readable instructions. In some such examples, the circuitry of FIGS. 8 and/or 7 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine-readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine-readable instructions and/or operations represented by the flowchart of FIG. 3.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. However, in some examples the L2 cache is connected to each core 802 and the shared memory 810 is implemented by level 3 (L3) cache for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer-based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

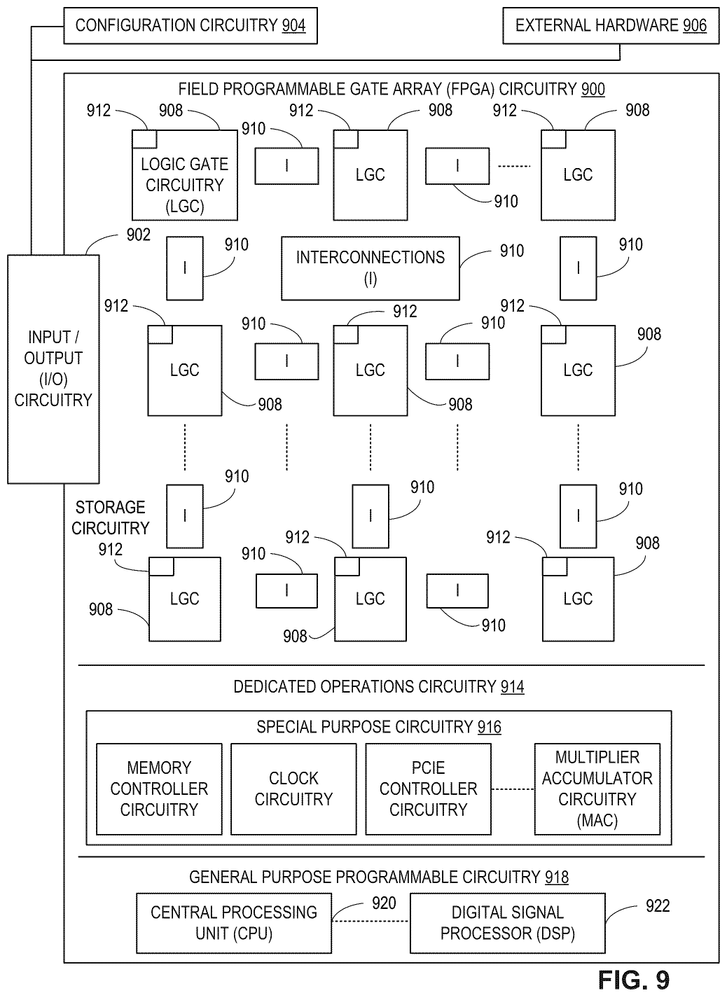

FIG. 9 is a block diagram of another example implementation of the programmable circuitry 912 of FIG. 9. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine-readable instructions. However, once configured, the FPGA circuitry 900 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine-readable instructions represented by the flowchart(s) of FIGS. 5-6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 5-6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 5-6. As such, the FPGA circuitry 900 may be configured and/or structured to effectively instantiate some or all of the operations/functions corresponding to the machine-readable instructions of the flowchart(s) of FIGS. 5-6 as dedicated logic circuits to perform the operations/functions corresponding to those software instructions in a dedicated manner analogous to an ASIC. Therefore, the FPGA circuitry 900 may perform the operations/functions corresponding to the some or all of the machine-readable instructions of FIGS. 5-6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High-Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine-readable instructions of FIGS. 5-6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine-readable instructions represented by the flowchart(s) of FIGS. 5-6 to perform first operation(s)/function(s), the FPGA circuitry 900 of FIG. 9 may be configured and/or structured to perform second operation(s)/function(s) corresponding to a second portion of the machine-readable instructions represented by the flowcharts of FIG. 3, and/or an ASIC may be configured and/or structured to perform third operation(s)/function(s) corresponding to a third portion of the machine-readable instructions represented by the flowcharts of FIG. 3.

It should be understood that some or all of the circuitry of FIGS. 8 and/or 9 may, thus, be instantiated at the same or different times. For example, the same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIGS. 8 and/or 9 may be instantiated, for example, in one or more threads executing concurrently and/or in series. For example, the microprocessor 800 of FIG. 8 may execute machine-readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the processor circuitry 800, 900 of FIGS. 8 and/or 9 may be implemented within one or more virtual machines and/or virtual execution environments executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIGS. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

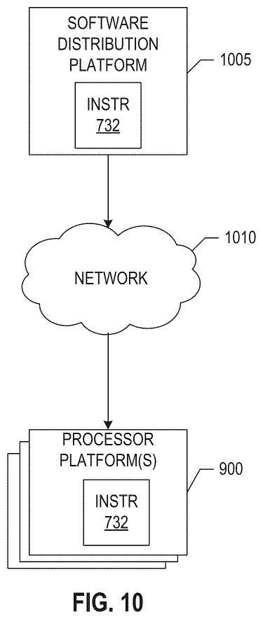

A block diagram illustrating an example software distribution platform 1005 to distribute software such as the example machine-readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine-readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine-readable instructions 732, which may correspond to the example machine-readable instructions of FIGS. 5-6, as described above. The one or more servers of the example software distribution platform 1005 are in communication with an example network 1010. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 732 from the software distribution platform 1005. For example, the software, which may correspond to the example machine-readable instructions of FIGS. 5-6, may be downloaded to the example programmable circuitry platform 700 which is to execute the machine-readable instructions 732 to implement the processor circuitry 712. In some examples, one or more servers of the software distribution platform 1005 periodically offer, transmit, and/or force updates to the software (e.g., the example machine-readable instructions 732 of FIG. 7) to ensure improvements, patches, updates, etc., are distributed and applied to the software at the end user devices. Although referred to as software above, the distributed “software” could alternatively be firmware.

Example methods, apparatus, systems, and articles of manufacture to automatically provisional peripheral data are disclosed herein. Further examples and combinations thereof include the following: Example 1 includes a non-transitory computer readable medium comprising instructions to cause at least one programmable circuit to use a machine learning model to select a first application or a second application based on context information associated with at least one of the first application, the second application, or an input signal from a peripheral device, and forward the input signal to the selected one of the first application or the second application.

Example 2 includes the non-transitory computer readable medium of example 1, wherein the instructions cause one or more of the at least one programmable circuit to block the input signal from reaching an unselected one of the first application or the second application.

Example 3 includes the non-transitory computer readable medium of example 1, wherein the selected one of the first application or the second application is to output the input signal via a network communication.

Example 4 includes the non-transitory computer readable medium of example 1, wherein the first application runs upon a host operating system and the second application runs upon a virtual execution environment.

Example 5 includes the non-transitory computer readable medium of example 1, wherein the instructions cause the at least one programmable circuit to forward the input signal to the selected one of the applications by forwarding the input signal to a virtual machine.

Example 6 includes the non-transitory computer readable medium of example 1, wherein the first application runs upon a first operating system of a first virtual machine and the second application runs upon a second operating system of a second virtual machine.

Example 7 includes the non-transitory computer readable medium of example 1, wherein the first application and the second application are implemented within a same virtual machine, the instructions to cause one or more of the at least one programmable circuit to forward the input signal to the selected one of the first application or the second application by forwarding the input signal to the virtual machine.

Example 8 includes the non-transitory computer readable medium of example 1, wherein the instructions cause one or more of the at least one programmable circuit to update the machine learning model based on at least one of user feedback or the context information corresponding to the input signal.

Example 9 includes the non-transitory computer readable medium of example 1, wherein the instructions cause one or more of the at least one programmable circuit to generate metadata to identify the selected one of the first application or the second application.

Example 10 includes the non-transitory computer readable medium of example 9, wherein the instructions cause one or more of the at least one programmable circuit to cause transmission of the metadata to an operating system.

Example 11 includes the non-transitory computer readable medium of example 1, wherein the instructions cause one or more of the at least one programmable circuit to obtain a first output signal from the first application and a second output signal from the second application, output the first output signal to a first peripheral device, and output the second output signal to a second peripheral device.

Example 12 includes the non-transitory computer readable medium of example 11, wherein the instructions cause one or more of the at least one programmable circuit to block the second output signal from the first peripheral device, and block the first output signal from the second peripheral device.

Example 13 includes the non-transitory computer readable medium of example 1, wherein the instructions cause one or more of the at least one programmable circuit to obtain a first audio signal from the first application and a second audio signal from the second application, output the first audio signal to a first peripheral device and block the second audio signal from the first peripheral device, convert the second audio signal into text, and output the text via a user interface.

Example 14 includes the non-transitory computer readable medium of example 13, wherein the instructions cause one or more of the at least one programmable circuit to block the second audio signal from the first peripheral device.

Example 15 includes the non-transitory computer readable medium of example 1, wherein the instructions cause one or more of the at least one programmable circuit to obtain a first output signal from the first application and a second output signal from the second application, input the first output signal to a model, input the second output signal to the model, and output an alert via a user interface based on an output of the model, the alert to draw attention of a user to at least one of the first application or the second application.

Example 16 includes the non-transitory computer readable medium of example 1, wherein the programmable circuit is implemented by at least one of a server or a driver.

Example 17 includes an apparatus comprising interface circuitry to obtain context information, machine readable instructions, and at least one programmable circuit to at least one of execute or instantiate the machine readable instructions to at least use a machine learning model to select a first application or a second application based on the context information associated with at least one of the first application, the second application, or an input signal from a peripheral device, and forward the input signal to the selected one of the first application or the second application.

Example 18 includes the apparatus of example 17, wherein one or more of the at least one programmable circuit is to block the input signal from reaching an unselected one of the first application or the second application.

Example 19 includes a method comprising selecting, using a machine learning model, a first application or a second application based on context information associated with at least one of the first application, the second application, or an input signal from a peripheral device, and forwarding the input signal to the selected one of the first application or the second application.

Example 20 includes the method of example 19, further including blocking the input signal from reaching an unselected one of the first application or the second application.

From the foregoing, it will be appreciated that example systems, apparatus, articles of manufacture, and methods have been disclosed to automatically provision, distribute and/or route peripheral data to one or more different recipients of a set of available recipients. Examples disclosed herein protect the privacy and/or security of a user by controlling how input and/or output data to/from peripheral devices is handled. In this manner, a user can utilize the same peripheral devices for different applications fluidly without additional actions from the user and with little (e.g., no or minimal) risk of input data from a peripheral being forwarded to an unintended application and, thus, reduce risk of exposing peripheral data to an incurrent person/audience. Thus, disclosed systems, apparatus, articles of manufacture, and methods are accordingly directed to one or more improvement(s) in the operation of a machine such as a computer or other electronic and/or mechanical device.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A non-transitory computer readable medium comprising instructions to cause at least one programmable circuit to:
use a machine learning model to select a first application or a second application based on context information associated with at least one of the first application, the second application, or an input signal from a peripheral device; and
forward the input signal to the selected one of the first application or the second application.

2. The non-transitory computer readable medium of claim 1, wherein the instructions cause one or more of the at least one programmable circuit to block the input signal from reaching an unselected one of the first application or the second application.

3. The non-transitory computer readable medium of claim 1, wherein the selected one of the first application or the second application is to output the input signal via a network communication.

4. The non-transitory computer readable medium of claim 1, wherein the first application runs upon a host operating system and the second application runs upon a virtual execution environment.

5. The non-transitory computer readable medium of claim 1, wherein the instructions cause the at least one programmable circuit to forward the input signal to the selected one of the applications by forwarding the input signal to a virtual machine.

6. The non-transitory computer readable medium of claim 1, wherein the first application runs upon a first operating system of a first virtual machine and the second application runs upon a second operating system of a second virtual machine.

7. The non-transitory computer readable medium of claim 1, wherein the first application and the second application are implemented within a same virtual machine, the instructions to cause one or more of the at least one programmable circuit to forward the input signal to the selected one of the first application or the second application by forwarding the input signal to the virtual machine.

8. The non-transitory computer readable medium of claim 1, wherein the instructions cause one or more of the at least one programmable circuit to update the machine learning model based on at least one of user feedback or the context information corresponding to the input signal.

9. The non-transitory computer readable medium of claim 1, wherein the instructions cause one or more of the at least one programmable circuit to generate metadata to identify the selected one of the first application or the second application.

10. The non-transitory computer readable medium of claim 9, wherein the instructions cause one or more of the at least one programmable circuit to cause transmission of the metadata to an operating system.

11. The non-transitory computer readable medium of claim 1, wherein the instructions cause one or more of the at least one programmable circuit to:
obtain a first output signal from the first application and a second output signal from the second application;
output the first output signal to a first peripheral device; and
output the second output signal to a second peripheral device.

12. The non-transitory computer readable medium of claim 11, wherein the instructions cause one or more of the at least one programmable circuit to:
block the second output signal from the first peripheral device; and
block the first output signal from the second peripheral device.

13. The non-transitory computer readable medium of claim 1, wherein the instructions cause one or more of the at least one programmable circuit to:
obtain a first audio signal from the first application and a second audio signal from the second application;
output the first audio signal to a first peripheral device and block the second audio signal from the first peripheral device;
convert the second audio signal into text; and
output the text via a user interface.

14. The non-transitory computer readable medium of claim 13, wherein the instructions cause one or more of the at least one programmable circuit to:
block the second audio signal from the first peripheral device.

15. The non-transitory computer readable medium of claim 1, wherein the instructions cause one or more of the at least one programmable circuit to:
obtain a first output signal from the first application and a second output signal from the second application;
input the first output signal to a model;
input the second output signal to the model; and
output an alert via a user interface based on an output of the model, the alert to draw attention of a user to at least one of the first application or the second application.

16. The non-transitory computer readable medium of claim 1, wherein the programmable circuit is implemented by at least one of a server or a driver.

17. An apparatus comprising:
interface circuitry to obtain context information;
machine readable instructions; and
at least one programmable circuit to at least one of execute or instantiate the machine readable instructions to at least:
use a machine learning model to select a first application or a second application based on the context information associated with at least one of the first application, the second application, or an input signal from a peripheral device; and
forward the input signal to the selected one of the first application or the second application.

18. The apparatus of claim 17, wherein one or more of the at least one programmable circuit is to block the input signal from reaching an unselected one of the first application or the second application.

19. A method comprising:
selecting, using a machine learning model, a first application or a second application based on context information associated with at least one of the first application, the second application, or an input signal from a peripheral device; and
forwarding the input signal to the selected one of the first application or the second application.

20. The method of claim 19, further including blocking the input signal from reaching an unselected one of the first application or the second application.
